(19) United States
(12) Patent Application Publication
(10) Pub. No.: US 2010/0007578 A1
(43) Pub. Date: Jan. 14, 2010

(54) IMAGE DISPLAY SYSTEM, IMAGE SUPPLY DEVICE, IMAGE DISPLAY DEVICE, CONTROL METHOD, AND CONTROL PROGRAM PRODUCT

(75) Inventors: Yosuke Kikuchi, Fuchu-shi (JP); Yuichi Kitazawa, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/486,821

(22) Filed: Jun. 18, 2009

(30) Foreign Application Priority Data
Jul. 8, 2008 (JP) 2008-178170

(51) Int. Cl. G09G 5/00

(52) U.S. Cl. 345/2.2; 345/1.1

(57) ABSTRACT

In at least one embodiment of the disclosure, an image display system includes an image supply device and one or more image display devices. Each of the image display devices includes a display section configured to display a first identification image to identify each of the image display devices. The image supply device includes a device determination/selection section. The device determination/selection section is configured to display one or more second identification images on a second display section. The second identification images have a correspondence with the first identification images and identify the image display devices. The image supply device receives selection, based at least on the second identification images, of at least one of the image display devices as a destination image display device. The image supply device supplies the image to the selected destination image display device.

### CROSS-REFERENCE

The present application claims priority from Japanese Patent Application No. 2008-178170 filed on Jul. 8, 2008, which is hereby incorporated by reference in its entirety.

### BACKGROUND

When giving a presentation, there are cases in which only an image field of a specific window rather than the entire screen displayed on a display device needs to be displayed on an external monitor. There is known a technology of outputting to an external monitor only an image of the window selected with a mouse pointer among a plurality of windows displayed on a display device (see, e.g., Japanese Patent Publication No. 2000-339130).

However, among other problems, when two or more image display devices are simultaneously connected to an image supply device, it is difficult to determine or select the image display device to display an image and to make correspondence between the images and the image display devices.

### SUMMARY

Various embodiments of the disclosure have been developed in response to the current state of the art, and in response to problems, needs, and demands that have not been fully or completely solved by currently available systems, devices and methods. For example, various embodiments may enhance convenience of operations in determining or selecting the image display device.

At least one embodiment is directed to an image display system including an image supply device, and N (N is an integer equal to or greater than 1) image display devices adapted to display an image supplied from the image supply device, wherein each of the image display devices includes a first display section adapted to display a first identification image used for identifying the image display device, and the image supply device includes a second display section, a device determination/selection section adapted to display N second identification images, which correspond to the first identification images and are used for identifying the N image display devices, on the second display section, and to execute, using the N second identification images, one of determination and selection of the image display device as a supply destination, and an image supply section adapted to supply image to the supply destination image display device one of determined and selected.

According to this embodiment, since the identification images are used when determining or selecting the supply destination image display device, it becomes possible to make the determination or selection of the image display device more easy, and enhance the convenience of the operation of the image display system.

At least one embodiment is directed to the image display system of the previously described embodiment, wherein the device determination/selection section displays M (M is an integer equal to or greater than 1) images to be supply objects on the second display section as supply candidate images in addition to the N second identification images, and makes correspondence between the supply candidate images and the second identification images, thereby executing one of determination and selection of the supply destination image display device and an image to be supplied.

According to this embodiment, it becomes possible to easily make the correspondence between the image display devices and the images to be supplied thereto, thus enhancing the convenience of the operation in determining or selecting the image display device.

At least one embodiment is directed to the image display system of at least one of the previously described embodiments, wherein the first identification images and the second identification images are the same, respectively.

According to this embodiment, it can be eliminated to make correspondence between the first identification images and the second identification images.

At least one embodiment is directed to the image display system of at least one of the previously described embodiments, wherein each of the image display devices includes a first storage section adapted to store the first identification image, and the image supply device obtains the first identification images from the respective image display devices, and displays the first identification images as the second identification images.

According to this embodiment, the image supply device is not required to previously store the identification images.

At least one embodiment is directed to the image display system of at least one of the previously described embodiments, wherein the image supply device includes a management section adapted to provide, when the plurality of first identification images obtained overlaps with each other, the image display device with a change instruction of the identification image so that the first identification images do not overlap with each other.

According to this embodiment, the first identification images are prevented from overlapping with each other.

At least one embodiment is directed to the image display system of at least one of the previously described embodiments, wherein the image supply device includes a storage section adapted to store the N second identification images, and each of the image display devices obtains the second identification image from the image supply device, and displays the second identification image as the first identification image.

According to this embodiment, since the image supply device supplies the identification images, the overlap of the identification images never occurs.

At least one embodiment is directed to the image display system of at least one of the previously described embodiments, wherein the device determination/selection section presents, when a plurality of image display devices are one of determined and selected as the supply destinations, the plurality of image display devices in a lump as candidates of one of the determination and the selection in subsequent execution of one of the determination and the selection of the supply destination image display device.

According to this embodiment, once the determination/selection of the image display device is executed, it becomes possible to save the trouble of determining/selecting the prearranged supply destination image display device in the second and later turns.

At least one embodiment is directed to an image supply device adapted to supply at least one image to N (N is an integer equal to or greater than 1) image display devices and including a display section, a device determination/selection section adapted to display N identification images, which are used for identifying the N image display devices, on the display section, and to execute one of determination and selection of the supply destination image display device using the N identification images, and an image supply section adapted to supply image to a supply destination image display device one of determined and selected.

According to this embodiment, since the identification images are used when determining or selecting the prearranged supply destination image display device, or the supply destination image display device, it becomes possible to make the determination or selection of the image display device easier, and enhance the convenience of operations of the image display device.

At least one embodiment is directed to an image display device including a storage section adapted to store an identification image, and a display section adapted to obtain the identification image from the storage section, and to display the identification image.

According to this embodiment, since the image display device holds the identification image, the image display device can easily display the identification image, thus it becomes possible to make the image display devices more distinguishable.

At least one embodiment is directed to the image display device of at least one previously described embodiment, wherein the storage section stores a plurality of identification images, and the image display device further includes a selection section adapted to select an arbitrary identification image from the storage section.

Although when using a plurality of image display devices, there is a possibility that the identification images overlap (i.e. are the same or similar) with each other, according to this embodiment, since the image display device has a plurality of identification images, by selecting the identification image therefrom, the overlap of the identification images can be reduced or eliminated, thus it becomes possible to make the image display devices more distinguishable.

At least one embodiment is directed to the image display device of at least one the previously described embodiments, wherein an obtaining section adapted to externally obtain the identification image is further provided.

According to this embodiment, since the image display device is capable of obtaining the identification image from the outside, it becomes possible to make the image display devices further more distinguishable.

It should be noted that the embodiments can be realized in various forms such as an image display control method, an image display control program product, or a storage medium storing the image display control program product besides the image display system, the image supply device, and the image display device.

### BRIEF DESCRIPTION OF THE DRAWINGS

Non-limiting and non-exhaustive embodiments of the present disclosure will now be described with reference to the accompanying drawings, wherein like reference numbers reference like elements.

FIG. 1 is an explanatory diagram showing a schematic configuration of an image supply system including an image supply device according to at least one embodiment.

FIG. 2 is a functional block diagram schematically showing an internal configuration of the image supply device according to an embodiment.

FIG. 3 is an explanatory diagram showing an example of a configuration of an identification image management file Fl.

FIG. 4 is a functional block diagram schematically showing an internal configuration of an image display device used in an embodiment.

FIG. 5 is an explanatory diagram showing an example of a configuration of an identification image management file F34.

FIG. 6 is a flowchart showing an operation of the image display device.

FIG. 7 is a flowchart showing an operation of the image supply device.

FIG. 8 is a flowchart showing an operation of the image supply device.

FIG. 9 is an explanatory diagram showing a screen displayed on an indication display 40 while acquiring display information I33.

FIG. 10 is an explanatory diagram showing a selection screen of the image display device 30.

FIG. 11 is an explanatory diagram showing an overall view of the image supply system when selecting the image display device.

FIG. 12 is an explanatory diagram showing a condition in which the image display device is selected.

FIG. 13 is an explanatory diagram showing an example of a correspondence relationship between the window storage areas A1 through A3 for storing displaying image data and display supplying storage areas SPJ1 through SPJ3.

FIG. 14 is an explanatory diagram showing an operation screen.

FIG. 15 is an explanatory diagram showing an image display system when the selection is completed.

FIG. 16 is an explanatory diagram showing an example of an operation of establishing correspondence between contents and the image display devices 30.

FIG. 17 is an explanatory diagram showing an example of an operation of establishing correspondence between contents and the image display devices 30.

FIG. 18 is an explanatory diagram showing the image display system displaying images on the image display devices.

FIG. 19 is an explanatory diagram showing the image display system displaying windows respectively on two image display devices 30 (PJ1, PJ3).

FIG. 20 is a flowchart illustrating operations of the image display device 30 and the image supply device 20 in an alternative embodiment.

FIG. 21 is a flowchart illustrating operations of the image display device 30 and the image supply device 20 in an alternative embodiment.

FIG. 22 is a flowchart showing an operation of the image supply device in an alternative embodiment.

FIG. 23 is an explanatory diagram showing a selection screen of a destination image display device or a group.

### DESCRIPTION OF EMBODIMENTS

In the following description, reference is made to the accompanying drawings which form a part hereof, and in which are shown, by way of illustration, specific embodiments in which the disclosure may be practiced. It is to be understood that other embodiments may be utilized and structural or logical changes may be made without departing from the scope of the present disclosure. Therefore, the following description is not to be taken in a limiting sense, and the scope of the present disclosure is defined by the appended claims and their equivalents.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” “one,” and “the” may include reference to both the singular and the plural. Reference in the specification to “one embodiment” or “an embodiment” means that a particular feature, structure, or characteristic described in connection with the embodiment may be included in at least one embodiment of the disclosure. The appearances of the phrases “in one embodiment” or “in an embodiment” in various places in the specification do not necessarily all refer to the same embodiment, but it may.

Several embodiments will sequentially be described under corresponding section headings below. Section headings are merely employed to improve readability, and they are not to be construed to restrict or narrow the present disclosure. For example, the order of description headings should not necessarily be construed so as to imply that these operations are necessarily order dependent or to imply the relative importance of an embodiment. Moreover, the scope of a disclosure under one section heading should not be construed to restrict or to limit the disclosure to that particular embodiment, rather the disclosure should indicate that a particular feature, structure, or characteristic described in connection with a section heading is included in at least one embodiment of the disclosure, but it may also be used in connection with other embodiments.

The method or procedure is described in terms of firmware, software, and/or hardware with reference to the flowchart. Describing a method by reference to a flowchart enables one skilled in the art to develop programs, including instructions to carry out the processes and methods on suitably configured computer systems and processing devices. In various embodiments, portions of the operations to be performed by the image supply system may constitute circuits, general purpose processors (e.g., micro-processors, micro-controllers, an ASIC, or digital signal processors), special purpose processors (e.g., application specific integrated circuits or ASICs), firmware (e.g., firmware that is used by a processor such as a micro-processor, a micro-controller, and/or a digital signal processor), state machines, hardware arrays, reconfigurable hardware, and/or software made up of executable instructions. The executable instructions may be embodied in firmware logic, reconfigurable logic, a hardware description language, a state machine, an application-specific integrated circuit (ASIC), or combinations thereof.

With respect to various embodiments using a software implementation (e.g., a hardware simulator), at least one of the processors of a suitably configured processing device executes the instructions from a storage and/or recording medium. The computer-executable instructions may be written in a computer programming language or executable code. If written in a programming language conforming to a recognized standard, such instructions may be executed on a variety of hardware platforms and may interface with a variety of operating systems. Although the various embodiments are not described with reference to any particular programming language, it may be appreciated that a variety of programming languages may be used to implement the teachings of the embodiments as described herein. Furthermore, it is common in the art to speak of software in one form or another (e.g., program, procedure, process, application, etc.) as taking an action or causing a result. Such expressions are merely a shorthand way of saying that execution of the software causes the processor to perform an action or to produce a result.

### First Embodiment

### Configuration of Image Supply System

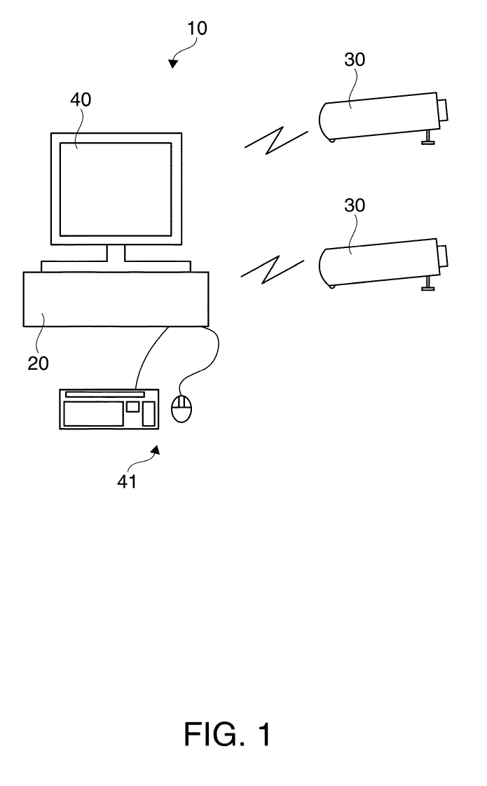

FIG. 1 is an explanatory diagram showing a schematic configuration of an image supply system including an image supply device according to a first embodiment. The image supply system 10 is provided with an image supply device 20 and image display devices 30. It should be noted that the image supply system 10 is referred to also as an image display system 10, and the image supply device 20 is referred to also as an image transfer device. A plurality of image display devices 30 is connected to the image supply device 20. The image supply device 20 and the image display devices 30 are connected to each other via, for example, a wireless local area network (LAN).

### Configuration of Image Supply Device

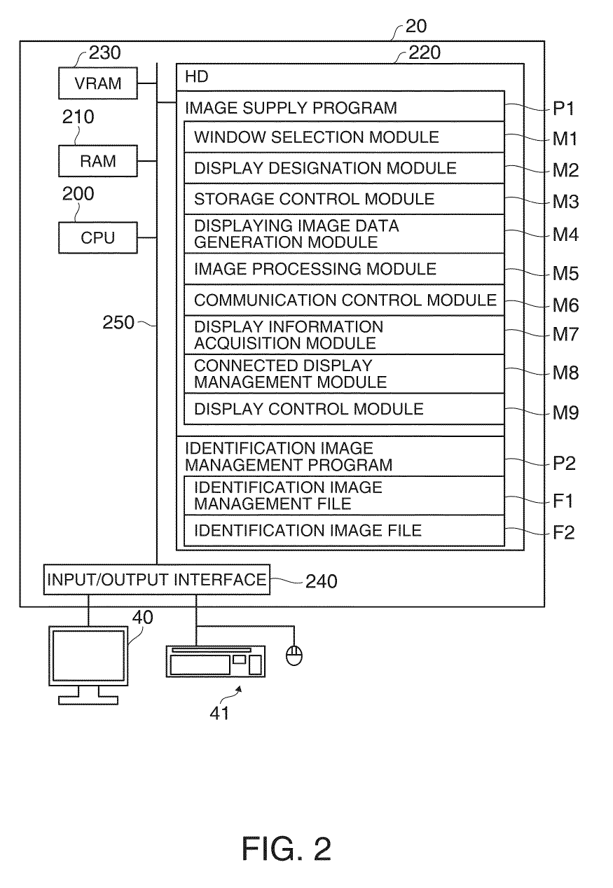

FIG. 2 is a functional block diagram schematically showing an internal configuration of the image supply device according to the first embodiment. The image supply device 20 is, for example, a personal computer, and is connected to an indication display 40, and input equipment 41 such as a keyboard or mouse. The image supply device 20 is provided with a central processing unit (CPU) 200, a random access memory (RAM) 210, a hard disk drive (HDD) 220, a drawing memory (VRAM) 230, and an input/output interface 240. The CPU 200, the RAM 210, the HDD 220, the VRAM 230, and the input/output interface 240 are connected to each other via a common bus 250 so as to allow bi-directional communication.

The CPU 200, which is a logic circuit for executing various kinds of arithmetic processing, expands various programs and modules, which are stored in, for example, the HDD 220, in the RAM 210, and then executes them. The RAM 210 is a volatile memory, and stores temporarily the operation results of the CPU 200, and the displaying image data to be supplied to the image display devices 30. The VRAM 230 is a memory device for expanding and then temporarily buffering the displaying image data drawn based on the data, and is generally capable of reading and writing the data faster than the RAM 210.

The HDD 220 is a magnetic disk storage device for storing an image supply program P1 and an identification image management program P2. It should be noted that a nonvolatile semiconductor memory can also be provided instead of the HDD 220. The image supply program P1 stored in the HDD 220 is provided with a window selection module M1, a display designation module M2, a storage control module M3, a displaying image data generation module M4, an image processing module M5, a communication control module M6, a display information acquisition module M7, a connected display management module M8, and a display control module M9. The identification image management program P2 is provided with an identification image management file F1 and an identification image file F2. It should be noted that the functions of the modules are realized by the CPU 200 executing the respective modules.

The image supply program P1 is a program for supplying the image display device (s) with the image displayed on the indication display 40 connected to the image supply device 20. More specifically, the image supply program P1 in the present embodiment is capable of supplying each of image display devices with a plurality of contents displayed on the indication display 40 content by content. Here, the content denotes a display screen provided application by application, and includes each of word processing screens in word processing software, each of presentation screens in presentation software, a replay screen for reproducing the moving image content, which is delivered by the stream, and an edit screen and a display screen of a still image. Further, a so-called desktop screen displayed as a background of the indication display 40 is also included in the content. It should be noted that each of these contents is called a window in the case of using Windows (a registered trademark) as an operating system, and therefore, is hereinafter referred to also as a “window.”

The window selection module Ml is a module executed for selecting a desired window among a plurality of windows displayed on the indication display 40. Specifically, the window selection module Ml specifies the window selected by the operator via the input equipment 41 among the plurality of windows. For example, by attaching unique numbers respectively to the windows (the windows opened on the screen) displayed on the indication display 40, it is possible to identify the windows, and specify the selected window. It should be noted that although it is possible that only one window is displayed on the indication display 40, in this case, the window selection module M1 specifies the window determined by the operator via the input equipment 41.

The display designation module M2 is a module for designating the image display device 30 to which the window selected by the window selection module M1 is output.

The storage control module M3 is a module for storing the selected window and the designated image display device 30 into the RAM 210 or the HDD 220 so as to be correlated with each other. The storage control module M3 also allocates window storage areas (content storage areas) for storing the displaying image data of the windows and display supplying storage areas for storing the image data transmitted to the image display devices 30 previously on the RAM 210 in accordance with the number of windows at least a part of which is displayed on the indication display 40, the number of image display devices 30 connected to the image supply devices 20, and the maximum resolution of the indication display 40. It should be noted that it is sufficient to allocate either one of the corresponding number of window storage areas to the number of windows and the corresponding number of display supplying storage areas to the number of image display devices 30 in the RAM 210 or the HDD 220.

The displaying image data generation module M4 is a module for generating the displaying image data of each of the windows displayed on the indication display 40. The displaying image data generation module M4 is capable of generating the displaying image data with respect to the windows existing on the indication display 40, in other words, all of the windows including the window hidden by another window and the window a part of which runs off the display screen of the indication display 40 and is not displayed thereon. This process is realized by, for example, drawing the displaying image data once on the VRAM 230 with respect not only to the window (the active window) in operation but to other windows when the window is selected, and then storing the displaying image data, thus drawn, at a predetermined location in the RAM 210. In this case, the display of other windows than the active window can be updated by executing the drawing process with respect to the other windows every time the other windows are selected. Alternatively, in the case in which the capacity of the VRAM 230 is large enough, it is possible to store the displaying image data of a plurality of windows on the VRAM 230.

The image processing module M5 is a module for executing various image processing on the displaying image data to be supplied to the image display devices 30. The image processing executed by the image processing module M5 includes a process such as a resolution conversion process, a sharpness control process, a brightness control process, or a color balancing process. Further, in the present embodiment, the image processing module M5 executes a process of modifying the displaying image data to be transmitted to the image display devices 30 in accordance with various operations, such as movement operation or modification operation (resizing operation), to a layout display window, which is displayed within a layout displaying area on the indication display 40. Specifically, the image processing module M5 moves the projection position of the image to be projected by the image display device 30 in response to the movement operation to the layout display window, and modifies the image to be projected by the image display device 30 in response to the modification operation to the layout display window.

The communication control module M6 is a module for controlling the input/output interface 240 for controlling transmission of connection information to, connection establishment with, and transmission of the displaying image data to the image display device 30, or performing reception of display information I33 from the image display device 30.

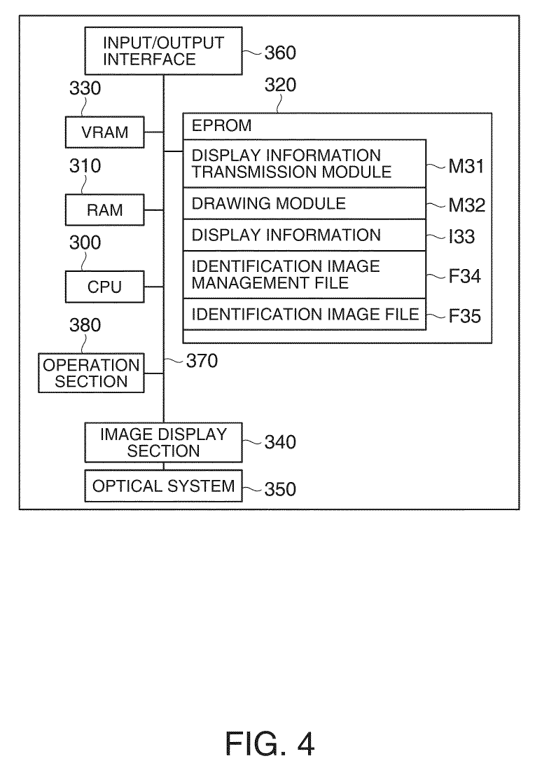

The display information acquisition module M7 is a module for acquiring the display information I33 (see FIG. 4) from the image display device 30. The display information I33 includes, for example, the maximum resolution supported by the image display device 30, a color profile (e.g., ICC profile) of the image display device 30, identification information for specifying the image display device 30, and other information related to the image reproducing characteristic of the image display device 30.

The connected display management module M8 is a module for managing the number of image display devices 30 connected to the image supply device 20, namely connection and disconnection of the image display devices 30 to the image supply device 20.

The display control module M9 is a module for displaying an image on the indication display 40 using the displaying image data, and at the same time displaying the layout displaying area and the layout display window in a predetermined area on the indication display 40. The display control module M9 also modifies the display of the layout display window based on the operations, such as movement operation or modification operation (resizing operation), to the layout display window. The display control module M9 also modifies the size of the window displayed on the indication display 40 if the operation to the layout display window is the modification operation (resizing operation). Further, the display control module M9 displays a plurality of layout displaying areas with respect to the layout display window of the window running off the screen of the indication display 40, and displays the layout display window including the part thereof running off the screen of the indication display 40 through the plurality of layout displaying areas.

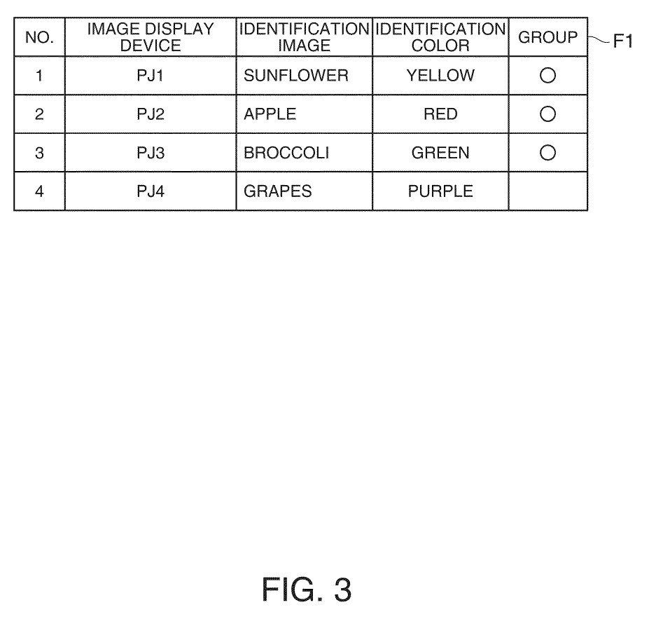

The identification image management program P2 manages the correspondence between the image display devices 30 and identification images using the identification image management file F1 and the identification image file F2. FIG. 3 is an explanatory diagram showing an example of a configuration of the identification image management file F1. The identification image management file F1 stores an identification image and correspondence with the identification color for each of the image display devices 30. The identification image file F2 stores the data of the identification images. Although in the present embodiment the identification image file F2 stores the image data of “a sunflower,” “an apple,” “broccoli,” and “grapes,” any images can be adopted providing the images can be distinguished from other images.

The input/output interface 240 shown in FIG. 2 is provided with a transmission/reception section for communicating signals between the image supply device 20 and external equipment such as the image display devices 30 in, for example, a wireless manner, and including switches for switching antennas and transmission/reception. Since the transmission/reception section is provided, an antenna access point (AP) function or a station (STA) function for transmitting/receiving the transmission signals and the reception signals is realized. The input/output interface 240 also receives an input signal from the input equipment 41 such as a keyboard or a mouse, and outputs the displaying image data to the indication display 40.

A “device determination/selection section” is realized using, for example, the display designation module M2, the storage control module M3, the display information acquisition module M7, the connected display management module M8, the display control module M9, and the identification image management program P2. When making correspondence between the windows and the image display devices 30, the window selection module M1 is also used as the device determination/selection section in addition thereto. The “image supply section” is realized using, for example, the displaying image data generation module M4, the image processing module M5, and the communication control module M6.

### Configuration of Image Display Device

FIG. 4 is a functional block diagram schematically showing an internal configuration of the image display device used in the first embodiment. The image display device 30 corresponds to, for example, a projector. As shown in FIG. 4, the image display device 30 is provided with a central processing unit (CPU) 300, a random access memory (RAM) 310, a nonvolatile memory (EPROM) 320, a drawing memory (VRAM) 330, an image display section 340, an optical system 350, an input/output interface 360, and an operation section 380. The CPU 300, the RAM 310, the EPROM 320, the VRAM 330, the image display section 340, the input/output interface 360, and the operation section 380 are connected to each other via a common bus 370 so as to allow bi-directional communication.

The CPU 300, which is a logic circuit for executing various kinds of arithmetic processing, expands various programs and modules, which are stored in, for example, the EPROM 320, in the RAM 310, and then executes them. The RAM 310 is a volatile memory device, and temporarily stores the result of calculation by the CPU 300. The VRAM 330 is a memory device for temporarily buffers the drawing data drawn based on the displaying image data.

The EPROM 320 is a semiconductor memory device for storing a display information transmission module M31, a drawing module M32, the display information I33, the identification image management file F34, and the identification image file F35. It should be noted that a magnetic disk storage device can also be used instead of the EPROM 320.

The display information transmission module M31 is a module for transmitting the stored display information to the image supply device 20. For example, when the connection between the image display device 30 and the image supply device 20 is established, the display information transmission module M31 acquires the stored display information I33, and then transmits the display information I33 to the image supply device 20 via the input/output interface 360.

The drawing module M32 analyzes the displaying image data received from the image supply device 20 via the input/output interface 360, and draws an image on the VRAM 330. Specifically, the drawing module M32 analyzes the displaying image data thus received to obtain the information such as the number of colors, sizes (vertical, lateral), coordinates, and image format, and then disposes pixel values in, for example, a bitmap manner on the VRAM 330 using the information thus obtained.

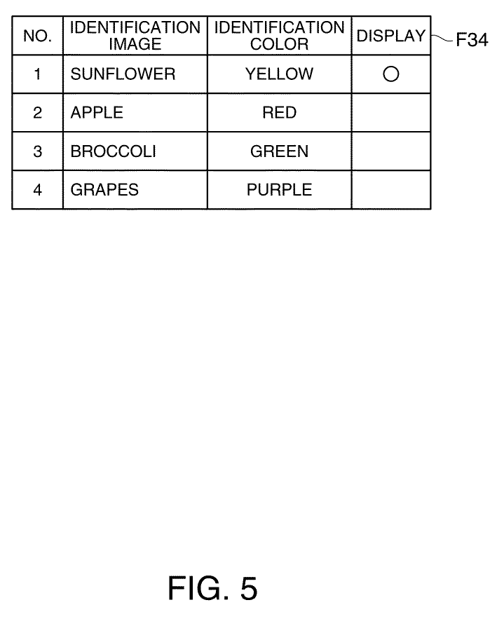

FIG. 5 is an explanatory diagram showing an example of a configuration of the identification image management file F34. The identification image management file F34 stores the identification images, a list of identification colors, and flags indicating which identification image is used as a default identification image. The identification image file F35 stores the data of the identification images. In the present embodiment the identification image file F35 stores the image data of a “sunflower,” an “apple,” “broccoli,” and “grapes,” and the image of a “sunflower” is set as the default image. It should be noted that although the default identification image is set to be different between the image display devices 30, if the default identification images overlap (i.e. are the same or similar) with each other, it is possible to change the default identification images by an operation in the operation section 380 or an instruction from the image supply device 20.

The image display section 340 is used for generating the image for projection using the image data stored in the VRAM 330. As the image display section 340, an image display section for modulating light beams from an RGB light source using liquid crystal panels, an image display section for modulating the light beams using digital micromirror devices (DMD) or reflective liquid crystal devices, for example, can be used without regard to the type thereof.

The optical system 350 is composed of a plurality of lenses, and is used for projecting the image generated in the image display section 340 on the projection surface with a predetermined size.

The operation section 380 is used when operating the image display device 30 manually, or when setting/modifying various settings. Here, the various settings includes, for example, setting of the network, and the setting of which identification image is set as the default identification image.

### Operation of Image Display Device

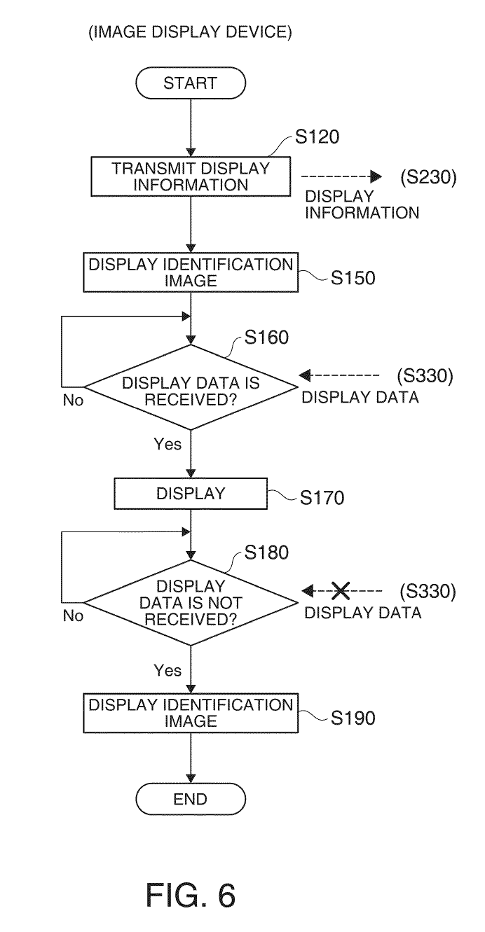

FIG. 6 is a flowchart showing an operation of the image display device.

When the image supply program P1 of the image supply device 20 is started, the image supply device 20 transmits a request for the display information I33. In step S120, the CPU 300 transmits the display information I33 to the image supply device 20. Specifically, in each of the image display devices 30, the CPU 300 executes the display information transmission module M31 to obtain the display information I33 from the ROM 320, and then transmit it to the image supply device 20. It should be noted that the display information I33 also includes the information representing which identification image the image display device 30 uses as the default identification image.

In step S150, the CPU 300 projects the identification image on a screen 50 using the image display section 340 and the optical system 350. Thus, the user understands which identification image corresponds to which image display device 30.

When receiving the display data from the image supply device 20 in step S160, the CPU 300 projects the display data on the screen using the image display section 340 and the optical system 350 in step S170. Further, when the image supply device 20 stops transmitting the display data in step S180, the CPU 300 projects the identification image on the screen using the image display section 340 and the optical system 350 in step S190.

### Operation of Image Supply Device

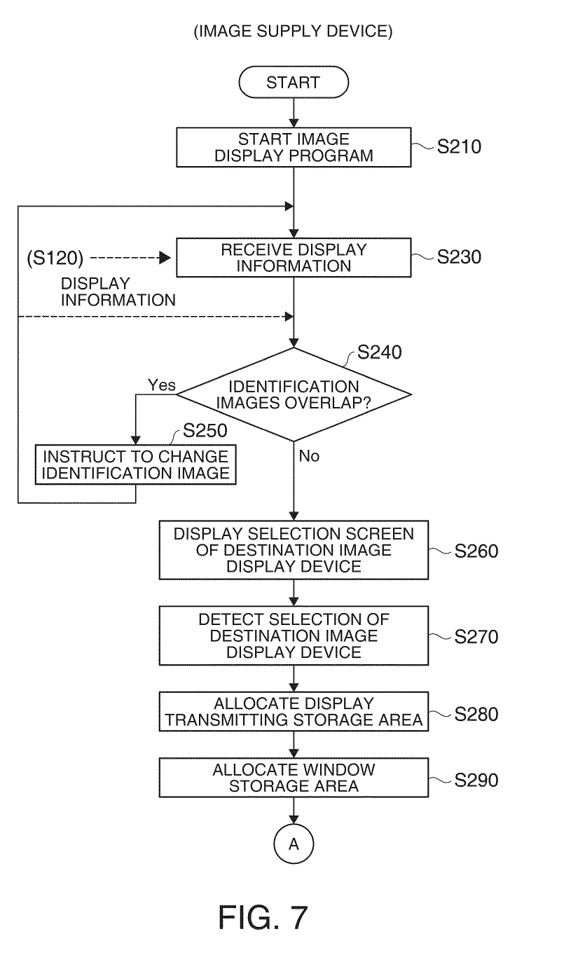

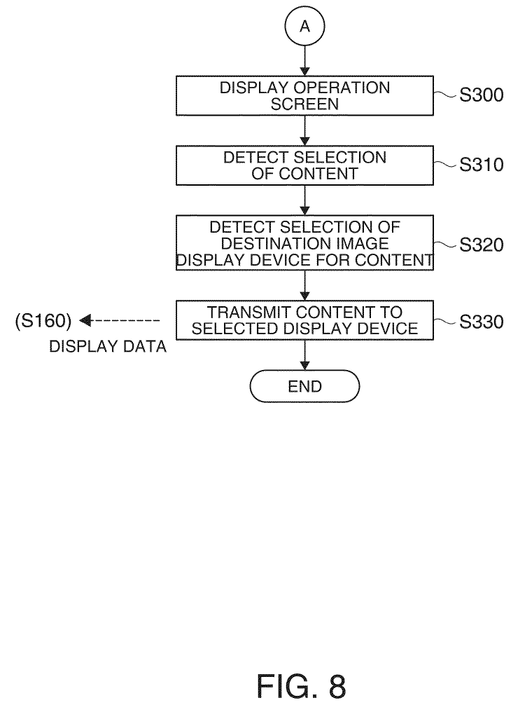

FIGS. 7 and 8 correspond to a flowchart representing an operation of the image supply device. When the image supply program P1 is started in step S210, the CPU 200 receives the display information I33 from the image display devices 30, and then stores the maximum supportable resolution, a color profile, identification information, and other image reproducing characteristics of each of the image display devices 30 in the HDD 220 with the correspondence with the image display device 30 in step S230 using the display information I33 obtained from the image display devices 30. As described above, the display information I33 also includes the information representing which identification image the image display device 30 uses. In step S240, the CPU 200 determines whether or not the identification images transmitted from different image display devices 30 overlap (i.e are the same or similar) with each other, and if the identification images overlap with each other, the CPU 200 executes display on the indication display 40 prompting to change the identification image in step S250.

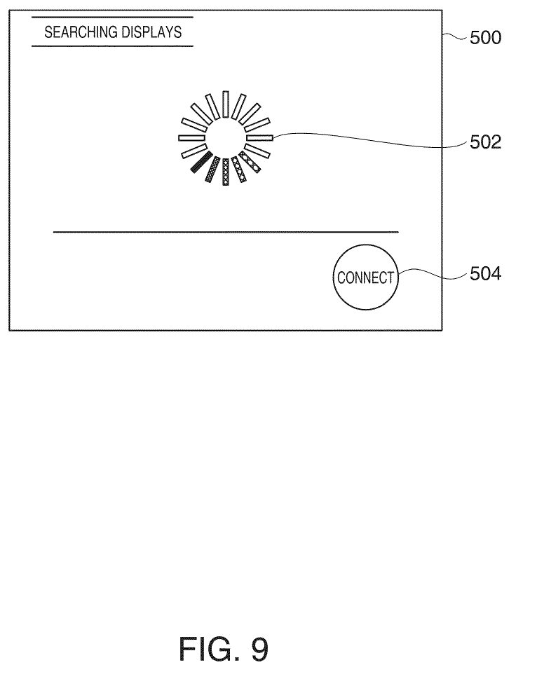

FIG. 9 is an explanatory diagram showing a screen displayed on the indication display 40 while acquiring the display information I33. In the display information acquisition screen 500, there are displayed an indicator 502 and a connection button 504, and when receiving the display information I33 from the image display device 30, the CPU 200 displays a selection screen for the image display device 30 in step S260 of FIG. 7.

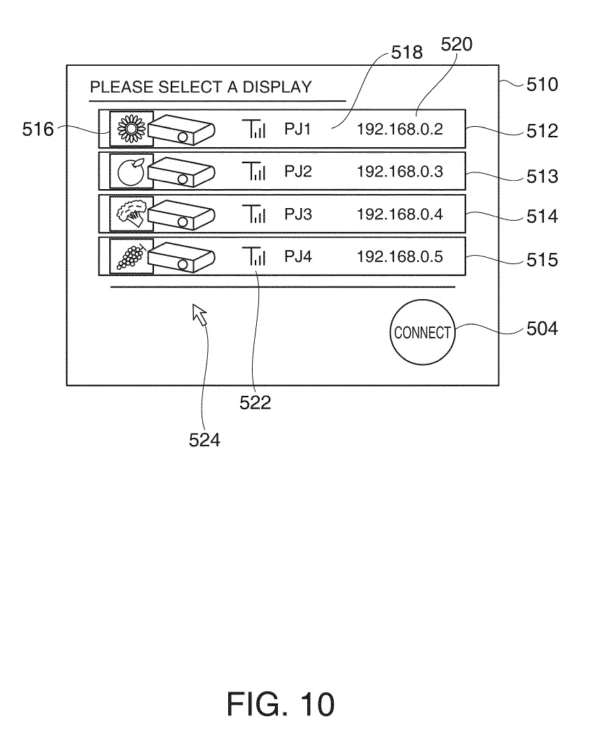

FIG. 10 is an explanatory diagram showing the selection screen for the image display device 30. On the selection screen 510, there are displayed selection columns 512 through 515 respectively representing all of the image display devices 30 which have received the display information I33, a mouse cursor 524, and a connection button 504. Each of the selection columns 512 through 515 is provided with an identification image display field 516, a device name display field 518, an IP address display field 520, and a radio strength display field 522.

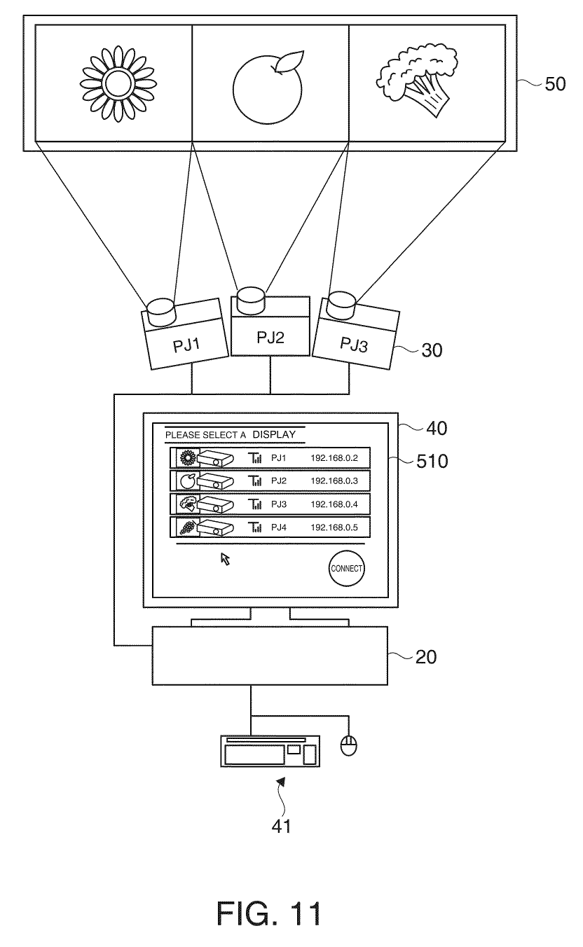

FIG. 11 is an explanatory diagram showing an overall view of the image supply system when selecting the image display device. The selection screen 510 shown in FIG. 10 is displayed on the indication display 40, and the projection images from the respective image display devices 30 are displayed on the screen 50. Here, on the selection screen 510, there are displayed four identification images corresponding respectively to the four image display devices 30, while the three identification images corresponding respectively to the image display devices 30, namely PJ1 through PJ3, are displayed on the screen 50. The reason therefor is that on the selection screen 510 the identification images of all of the image display devices 30 (PJ1 through PJ4) detected (from which the display information has been received) including the image display device 30 (PJ4) installed in a different meeting room. The identification image displayed in the identification image display field 516 is the same as the image projected from the corresponding image display device 30. Therefore, according to the present embodiment, since the user is allowed to select the image display devices 30 using the identification images displayed on the identification image display fields 516, it is more easy to determine or select the image display device 30, thus it becomes possible to enhance the convenience of operations of the image supply system 10. In step S270, the CPU 200 detects selection of the image display device 30.

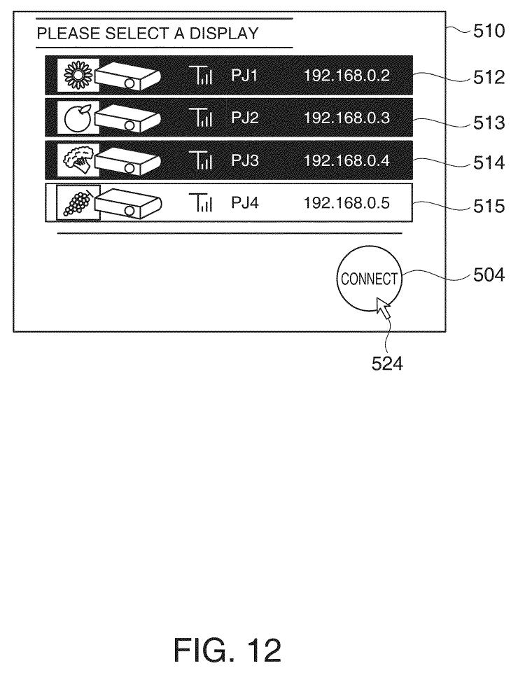

FIG. 12 is an explanatory diagram showing a condition in which the image display device is selected. In the drawing, the selection columns 512 through 514 out of the selection columns 512 through 515 are highlighted indicating that the three image display devices 30 corresponding to these selection columns 512 through 514 are selected. It should be noted that the CPU 200 can detect the selection of the image display device 30 by detecting a click on the selection columns 512 through 514 with the mouse cursor 524 located on the corresponding selection columns. When clicking the connection button 504 with the mouse cursor 524 located on the connection button 504, the connection with the selected image display device 30 is completed.

The CPU 200 executes the connected display management module M8 to specify the number of image display devices 30 connected to the input/output interface 240, and then executes the storage control module M3 to allocate the corresponding number of display supplying storage areas to the number of image display devices 30 connected thereto on the RAM 210 or the HDD 220 (step S280). The CPU 200 executes the storage control module M3 to allocate the corresponding number of window storage areas to the number of windows on the RAM 210 (step S290).

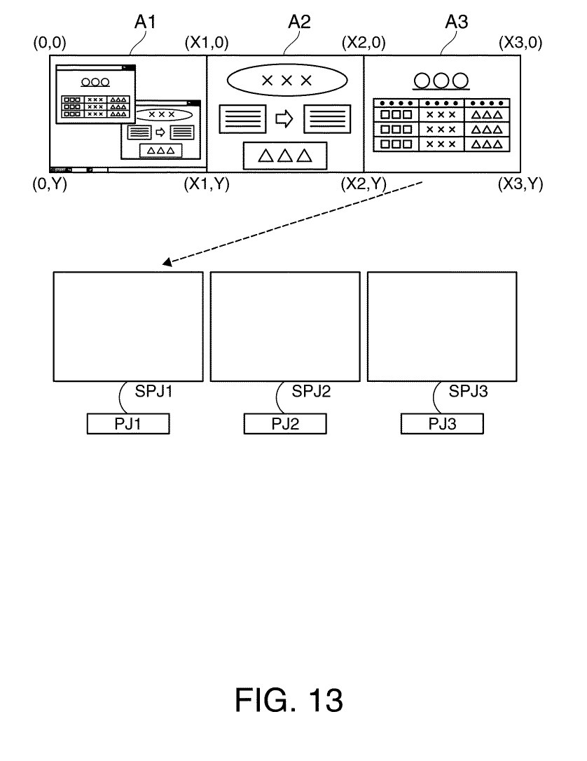

FIG. 13 is an explanatory diagram showing an example of a correspondence relationship between the window storage areas A1 through A3 for storing displaying image data and the display supplying storage areas SPJ1 through SPJ3. In the example shown in FIG. 13, the display supplying storage areas SPJ1 through SPJ3 are allocated (assigned) respectively to the image display devices 30 (PJ1 through PJ3). The number of image display devices 30 is specified by the CPU 200 detecting the number of wireless ports to which the image display devices 30 are connected, based on the detection of establishment of the connection in the wireless communication, for example. It should be noted that it is not necessarily required that the display supplying storage areas SPJ1 through SPJ3 are contiguous with each other, and the window storage areas A1 through A3 storing the displaying image data are contiguous with each other. Further, the capacities corresponding to the resolution of the primary display (the desktop screen) of the indication display 40 are assured in the display supplying storage areas SPJ1 through SPJ3.

For example, in Windows (a registered trademark), each of the windows is managed with a number called a handle, and the CPU 200 can obtain the handles of all of the windows displayed (opened) on the indication display 40 by executing the API function “EnumWindows.” Therefore, the CPU 200 allocates a plurality of window storage areas, which is necessary for storing all of the windows, in the RAM 210 in accordance with the number of handles thus obtained. It should be noted that as the capacity of each of the window storage areas, the capacity corresponding to the resolution of the desktop screen (the primary display) of the indication display is assured.

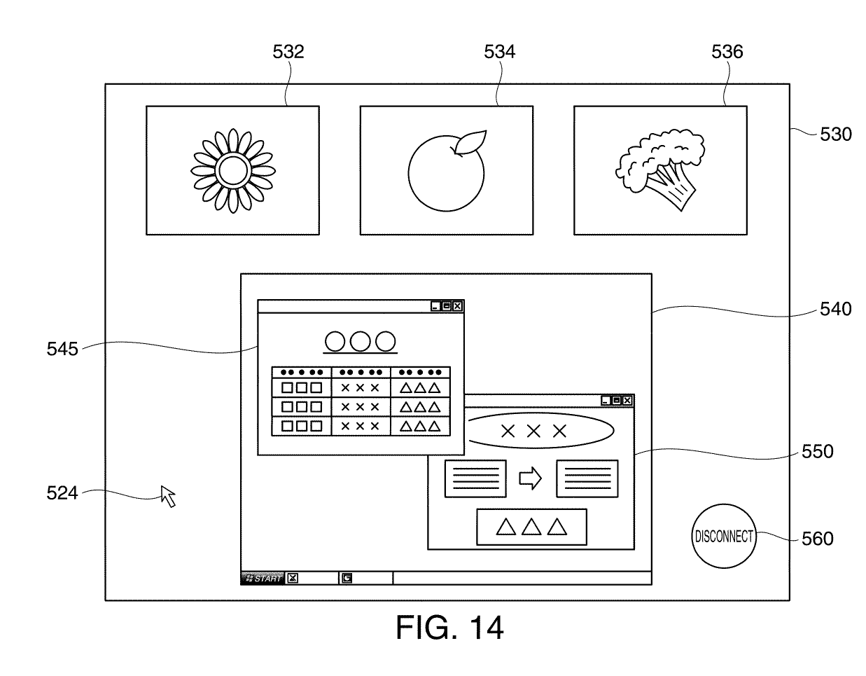

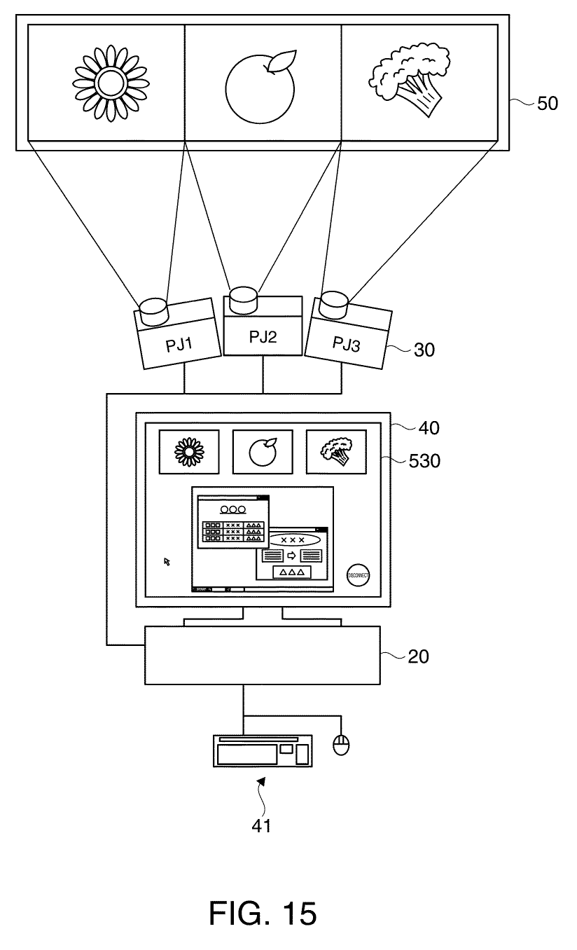

In step S300 shown in FIG. 8, the CPU 200 displays an operation screen 530. FIG. 14 is an explanatory diagram showing the operation screen. FIG. 15 is an explanatory diagram showing an image display system when the selection is completed. As shown in FIG. 14, on the operation screen 530, there are displayed small screens 532, 534, 536 and a desktop window 540. The number of small screens 532, 534, 536 corresponds to the number of selected image display devices 30. The images displayed of the small screens 532, 534, 536 are the same as the identification images projected by the image display devices 30 as shown in FIG. 15, and are displayed by, for example, writing the corresponding images from the identification image file F2 to the corresponding addresses to the small screen 532, 534, 536 of the VRAM 230. The desktop window 540 displays the entire desktop screen prior to start-up of the image supply program P1 in reduced size.

The CPU 200 executes the displaying image data generation module M4 to generate (capture) the displaying image data with respect to all of the windows displayed on the indication display 40. In the example shown in FIG. 14, two windows 545, 550 are displayed in the desktop window 540. These two windows 545, 550 can be said contents provided by application programs. It should be noted that in the case in which a part of the window runs off the desktop window 540, the displaying image data of the entire window including the part running off the desktop window 540 is generated although the part running off is not displayed on the desktop window 540. Further, the part running off includes a part running off the desktop window 540 in the case in which the window is located with an offset from the desktop window 540, and a part running off the desktop window 540 in the case in which the entire window is not fitted in the desktop window 540. Although the displaying image data thus generated can be fitted in a single window storage area in the former case, in the latter case, the displaying image data thus generated is stored in a plurality of window storage areas so as to straddle the window storage areas.

For example, in the case in which Windows (a registered trademark) is adopted as the operating system, by adopting a layered window, the displaying image data corresponding to all of the windows displayed on the indication display 40 is generated. The CPU 200 sequentially executes “GetWindowLong” as an API function for acquiring the setting values of the present window, an API function “SetWindowLong” for registering the present window style acquired in “GetWindowLong” after making OR with the layered setting API “WS_EX_LAYERED,” and an API function “SetLayeredWindowAttributes” for setting the layered parameters of the designated window, thereby making each of the windows a layered window. With respect to each of the windows made to be the layered window, the entire window is captured, in other words, the displaying image data corresponding to the entire window is generated.

The displaying image data generation module M4 develops (draws) the displaying image data based on the application programs corresponding respectively to the windows, thereby generating the displaying image data. The displaying image data thus generated is sequentially stored in the window storage area previously allocated on the RAM 210. In the example shown in FIG. 13, the displaying image data of the desktop window 540 is stored in the first window storage area A1, and the displaying image data of the windows 550, 545 are stored respectively in the second and third window storage areas A2, A3. In the present embodiment, the storage control module M3 manages the window storage areas A1 through A3 using the coordinates (X, Y), and for example, the location of the window (displaying image data) on the display screen of the indication display 40 is managed using the upper left coordinate point as the origin. Further, the projection position of the image with respect to the projection frame when projected actually corresponds to the storing position of the displaying image data stored in the respective window storage areas, and the position of the image thus projected can be specified by specifying the coordinate in the respective window storage areas. Further, it is also possible to specify the pixel data constituting the displaying image data using the coordinates applied to the window storage areas.

Returning to FIG. 8, in step S310, the CPU 200 detects selection of the content, and in step S320, the CPU 200 executes the display designation module M2 to detect selection of the image display device 30 to which the content is supplied.

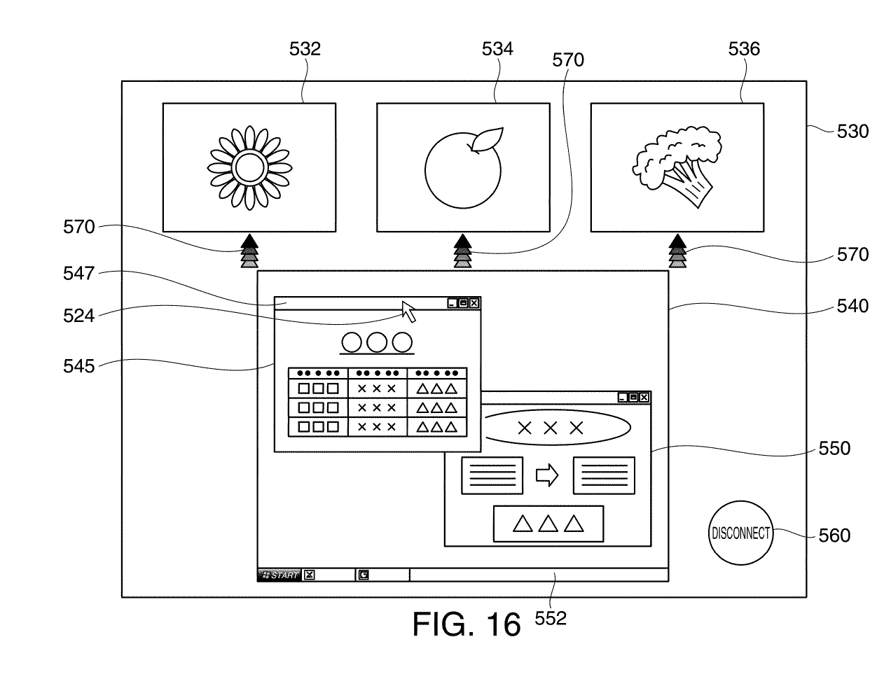

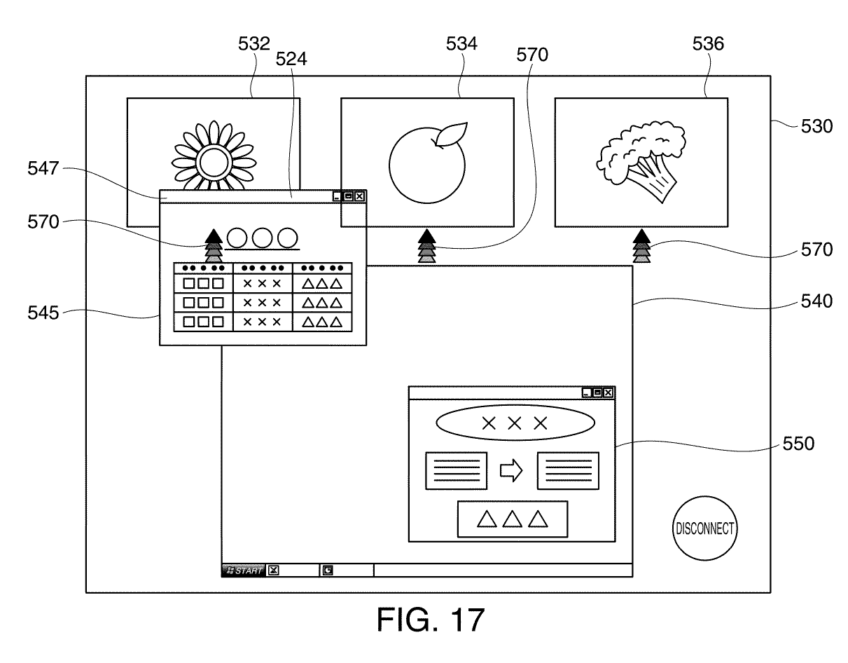

FIGS. 16 and 17 are explanatory diagrams showing an example of an operation of establishing correspondence between contents and the image display devices 30. When clicking the title bar 547 of the window 545 with the mouse cursor 524 located on the title bar, the window 545 is selected, and as shown in FIG. 16, arrows 570 to the small screens 532 through 536 corresponding to the image display devices 30 which can be displayed are displayed. As shown in FIG. 17, when dragging the mouse cursor 524 and then dropping the window 545 on the small screen as the destination of the arrow 570, the small screen 532, for example, the CPU 200 executes the storage control module M3 to make correspondence between the window 545 and the image display device 30 corresponding to the small screen 532. Specifically, the CPU 200 executes the storage control module M3 to make correspondence between the window storage area for storing the displaying image data corresponding to the selected window and the display supplying storage area corresponding to the designated image display device.

In step S330 of FIG. 8, the CPU 200 transmits the content of the selected window 545 to the selected image display device 30. Specifically, the CPU 200 executes the storage control module M3 to copy or move the displaying image data of the window 545 stored in the window storage area to the display supplying storage area as a supplying storage area to the image display device 30 (PJ1). It should be noted that the correspondence between the image display devices 30 (PJ1 through PJ3) and the respective storage areas can be realized by, for example, making a correspondence between the port numbers to which the image display devices 30 (PJ1 through PJ3) are respectively connected, or MAC addresses of the communication control modules of the respective image display devices 30 (PJ1 through PJ3) and the coordinate information for defining the respective storage areas.

When the correspondence between the selected window and the designated image display device has been established, the CPU 200 executes the image processing module M5 to execute necessary image processing on the displaying image data. In the present embodiment, the image processing to the displaying image data is executed on the respective display supplying storage areas SPJ1 through SPJ3. As the image processing, there are executed using the display information I33, for example, a resolution conversion process, an image quality control process such as a sharpness control process, a brightness control process, or a color balance control process, and a composition process of the displaying image data. In the case in which it is required to project a plurality of windows on one image display device 30 using the composition process, it is possible to supply the image display device 30 with the displaying image data along the image displayed on the indication display 40.

The CPU 200 further executes the communication control module M6 to supply the corresponding image display devices 30 (PJ1 through PJ3) with the displaying image data, on which the image processing has been executed and which is stored in the respective display supplying storage areas SPJ1 through SPJ3. It should be noted that after the correspondence between the window and the image display device 30 has been made, generation of the displaying image data of the window on the indication display 40 and transmission of the displaying image data to the respective image display devices 30 (PJ1 through PJ3) are repeatedly executed at predetermined timing. Alternatively, in the case in which the content does not vary with time, it is possible to execute generation of the displaying image data of the corresponding window and transmission of the displaying image data to the respective image display devices 30 (PJ1 through PJ3) at the timing when the window becomes active. Thus, it is possible to project the image corresponding to the latest window at any time after the correspondence between the window and the image display device 30 has once been established.

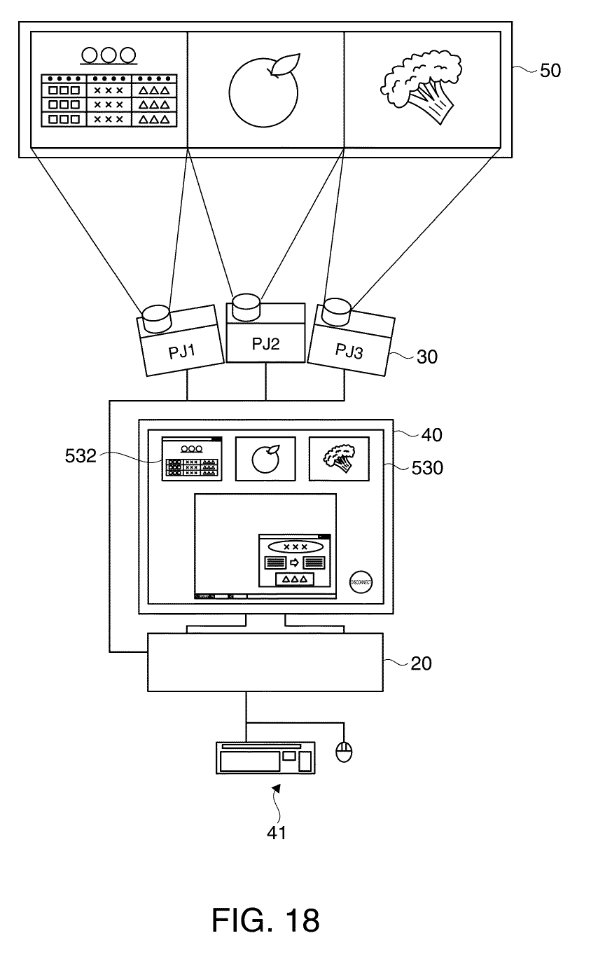

FIG. 18 is an explanatory diagram showing the image display system displaying images on the image display devices. The content (FIG. 14) having been displayed on the window 545 is displayed on the small screen 532 and the projection screen of the image display device 30 (PJ1). It should be noted that the identification images are displayed on the small screens 534, 536 and the projection screens of the image display devices 30 (PJ2, PJ3).

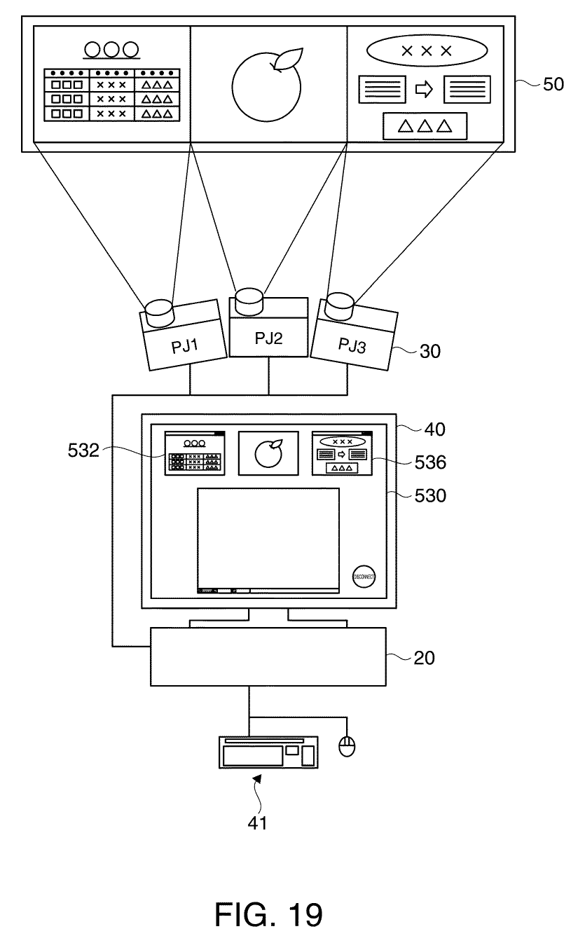

FIG. 19 is an explanatory diagram showing the image display system displaying windows respectively on two image display devices 30 (PJ1, PJ3). The content (FIG. 14) having been displayed on the window 545 is displayed on the small screen 532 and the projection screen of the image display device 30 (PJ1), and the content having been displayed on the window 550 is displayed on the small screen 536 and the projection screen of the image display device 30 (PJ3). As described above, it is also possible to supply a plurality of image display device 30 with images of a plurality of windows.

As described above, according to the present embodiment, since it is possible to perform selection of the image display device 30 using the identification images, it becomes possible to make the determination or the selection of the image display device 30 easier, thereby enhancing convenience of the operation of the image supply system 10. It should be noted that although in certain embodiments the identification image displayed by the image display device 30 is the same as the identification image displayed on the indication display 40 of the image supply device 20, it is possible to make the identification images different from each other providing the identification images correspond to each other.

Further, selection of the image display device to which an image is to be supplied and displayed may be performed by selecting the image display device from a list of possible destination image display devices, such as from a selection screen that includes a list of possible destination image display devices detected (see, e.g., FIGS. 10 through 12), and/or selecting an image supply device to which an image is supplied from among previously selected destination image display device(s) (see, e.g., FIGS. 14 through 17).

In the present embodiment, since the image supply device 20 causes the image display 30 to change the corresponding identification image in the event the identification images corresponding to the image display devices 30 overlap (i.e. the identification images are the same or similar) with each other, the overlap of identification images may be prevented.

### Second Embodiment

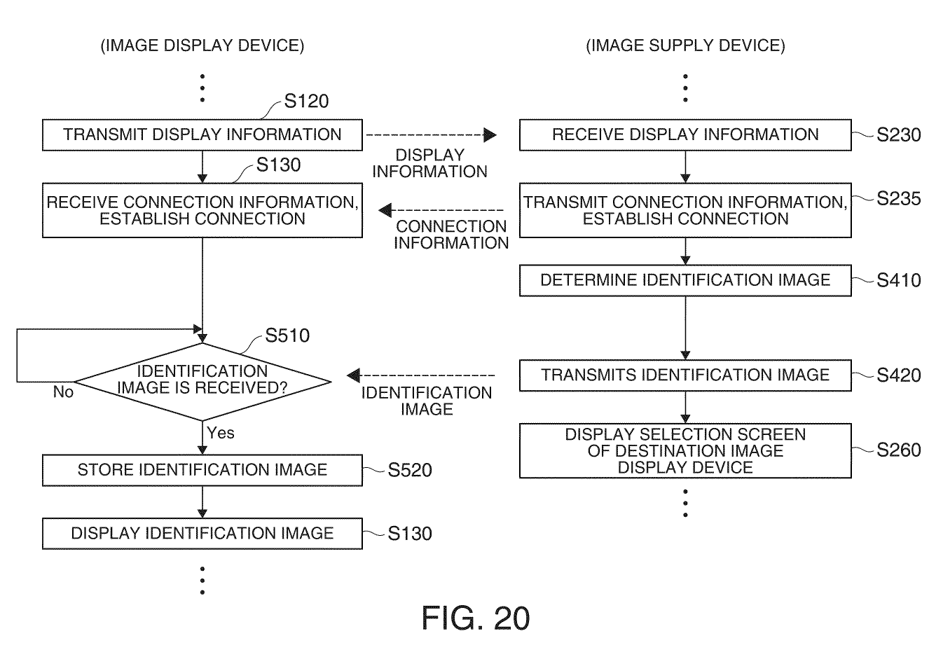

In the first embodiment, the identification images are displayed on the image supply device 20 based on the display information I33 received from the image display devices 30. The second embodiment is different therefrom in that the image supply device 20 previously stores the identification images and the image display devices 30 receive the identification images from the image supply device 20, and that the image display devices 30 and the image supply device 20 are connected automatically. FIG. 20 is a flowchart of operations of the image display devices and the image supply device in the second embodiment. Firstly, the operation of the image supply device 20 will be explained. When receiving the display information I33 in step S230, the image supply device 20 transmits connection information to the image display device 30 in step S235 to establish the connection. In step S410, the CPU 200 of the image supply device 20 determines the identification image to be transmitted to the image display device 30. It should be noted that the identification images are different between the image display devices 30. In step S420, the CPU 200 transmits the identification image to the image display device 30. The subsequent operations are the same as those in the first embodiment. Next, the operation of the image display device 30 will be explained. When receiving the connection information in step S130, the image display device 30 establishes the connection with the image supply device 20. When receiving the identification image in step S510, the CPU 300 of the image display device 30 stores the identification image into the RAM 310 in step S520. In step S150, the CPU 300 causes the screen 50 display the identification image. The subsequent operations are the same as those in the first embodiment.

As described above, the configuration in which the image supply device 20 previously stores the identification images may be adopted. According to such a configuration, the need for the inquiry from the image display device 30 to the image supply device 20 on whether the identification images overlap with each other can be eliminated.

### Third Embodiment

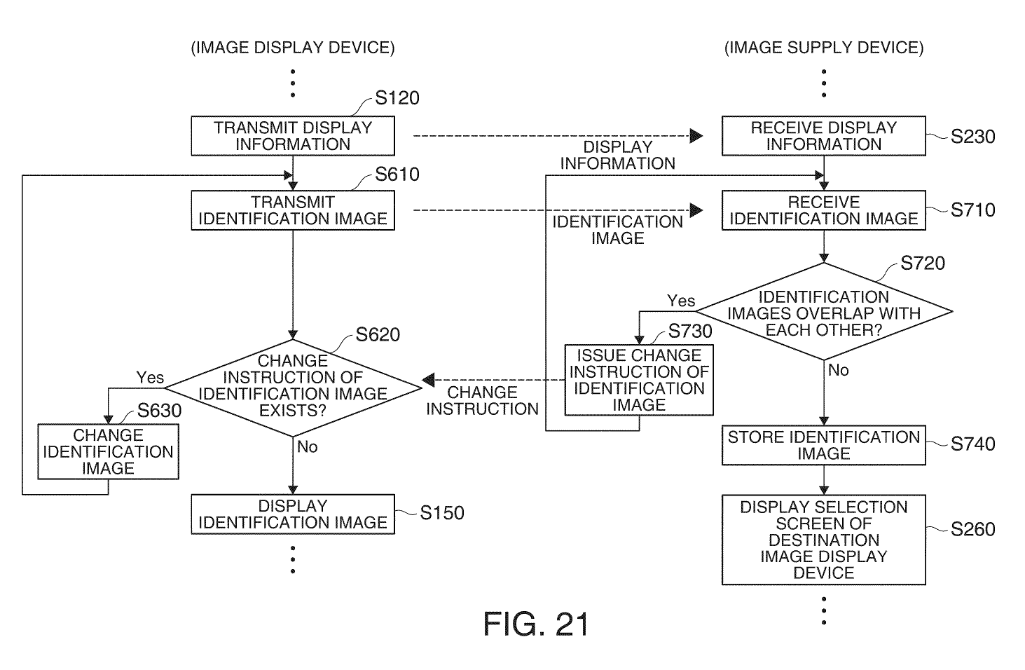

FIG. 21 is a flowchart of operations of the image display device 30 and the image supply device 20 in a third embodiment. The third embodiment is different therefrom in that the image display devices 30 previously store the identification images, and the image supply device 20 receives the identification images from the image display devices 30. Firstly, the operation of the image supply device 20 will be explained. When receiving the display information I33 in step S230, the image supply device 20 transmits the connection information to the image display device 30 in step S235 to establish the connection. The image supply device 20 receives the identification image in step S710. In step S720, the image supply device 20 determines whether the identification image overlaps any other identification images, and if the overlap exists, the image supply device 20 transmits a change instruction of the identification image to the image display device 30 in step S730. On the other hand, when the image display device 30 receives the request for the display information I33, the CPU 300 transmits the display information I33 in step S120. Subsequently, in step S610, the CPU 300 transmits the identification image to the image supply device 20. When receiving the change instruction of the identification image in step S620, the CPU 300 changes the identification image in step S630, and then returns to step S610 to transmit the identification image to the image supply device 20.

As described above, the configuration in which the image display devices 30 previously store the identification images can be adopted. According to this configuration, the need for storing the same identification images in both of the image display devices 30 and the image supply device 20 is eliminated. It should be noted that in the second and third embodiments, when selecting the image display devices 30 on which the images are attempted to be actually displayed among the image display devices 30 displayed in the selection columns 512 through 514, and then clicking the connection button 504, the connection with the image display device 30 (PJ4) not selected in the selection column 515 is disconnected, thereby the connection with the image display devices 30 thus selected is completed.

### Fourth Embodiment

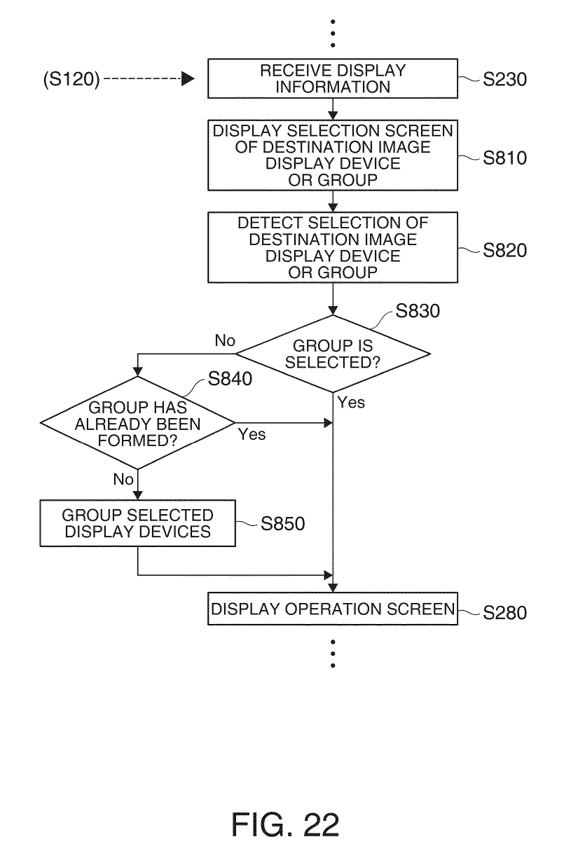

FIG. 22 is a flowchart showing an operation of the image supply device according to a fourth embodiment. According to the fourth embodiment, in the first through third embodiments, there is adopted a configuration that when the image display devices 30 as the destination image display devices are determined, these devices are lumped (i.e. grouped) with each other so that they can be treated in a lump in the second and later turns. When receiving the display information I33 in step S230, the CPU 200 makes the indication display 40 display a selection screen of the destination image display device or the group in step S810.

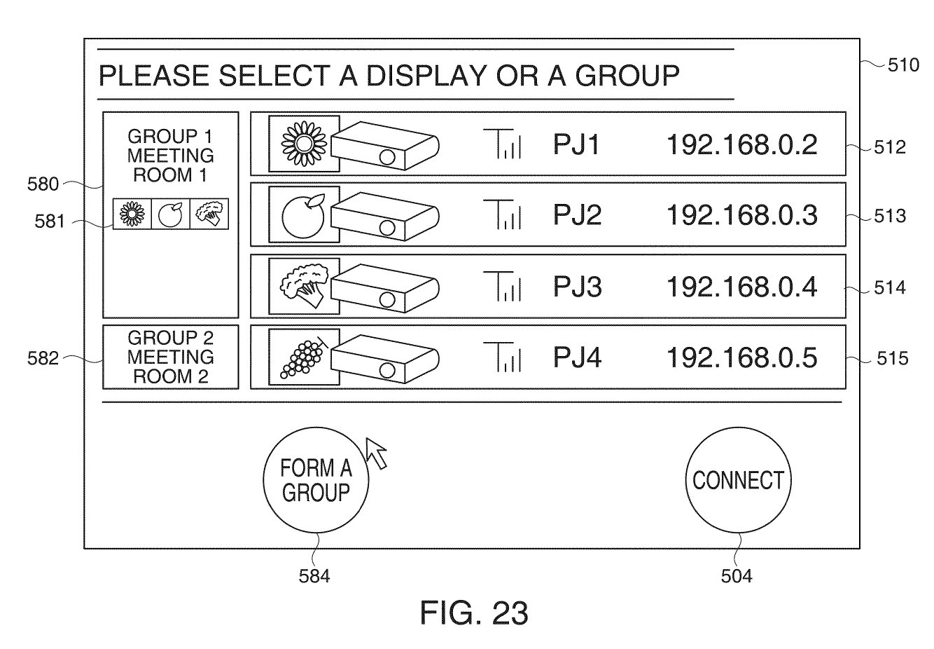

FIG. 23 is an explanatory diagram showing a selection screen of the destination image display device or the group. The selection screen 510 is provided with group selection fields 580, 582 and a group formation button 584 in addition to the configuration of the selection screen in the first embodiment. The group selection field 580 is provided with an identification image display area 581 for showing the image display devices 30 included in the group.

In step S820, the CPU 200 detects selection of the image display device 30 or selection of the group. These selections are executed by clicking the selection columns 512 through 515 or the group selection fields 580, 582 similarly to the first embodiment. In step S830, the CPU 200 determines whether or not the group is selected. If the group is selected, the CPU 200 moves the process to step S280 to make the indication display 40 display the operation screen 530. If the image display device 30 is selected instead of the group, whether or not the group including the same image display device has been formed is determined in step S840. If the group has been formed, the CPU 200 moves the process to step S280 to cause the indication display 40 display the operation screen 530. If the group has not been formed, the CPU 200 forms a new group in step S850. The group thus formed is displayed in the group selection field in and after the subsequent turn. It should be noted that there can also be adopted the configuration that when, for example, the group formation button is selected in the condition in which some of the selection columns 512 through 515 are selected, the CPU 300 forms a group including the image display devices 30 thus selected. Further, it is also possible that when the group formation button is selected in the condition in which some of the selection columns 512 through 515 and one of the group selection fields 580, 582 are selected, the CPU 300 can replace the image display devices 30 constituting the group corresponding to the group selection field thus selected with the image display devices 30 thus selected.

As described hereinabove, according to the fourth embodiment, since it becomes possible to treat the image display devices having once been selected as a group, and to present the plurality of image display devices in a group as the candidates for selection in the second and later turns, it becomes possible to enhance the operational convenience of the image supply system 10.

### Modified Embodiments

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments in accordance with the present disclosure may be implemented in a very wide variety of ways.

For example, although in the present embodiments the images including designs such as a “sunflower” are used as the identification images, images with simple patterns such as a checkered pattern, images with simple graphic symbols such as a circle, a rectangle, or a triangle, and monochromatic images can also be used as the identification images as long as the images are identifiable. Further, the identification images can be added or corrected. Further, although in the first embodiment, the identification images are transmitted to check the overlap, it is also possible to transmit identification symbols with which the identification images can be specified.

As another example, although in the present embodiments the image supply device 20 and the image display devices are connected to each other using a wireless LAN, it is also possible to connect them using, for example, a wired LAN, Universal Serial Bus (USB), or a cable CV.

Although the disclosure is hereinabove explained based on some specific examples, the embodiments of the disclosure described above are only for making it easier to understand the disclosure, but not for limiting the scope of the disclosure. It should be readily appreciated that the disclosure may be modified or improved without departing from the scope of the disclosure and the present disclosure should be limited only by the appended claims and the equivalents thereof.

What is claimed is:

1. An image display system comprising:
one or more image display devices configured to display an image, wherein each of the image display devices includes a first display section configured to display a first identification image to identify each of the image display devices; and
an image supply device configured to supply the image to the image display devices, the image supply device including
a second display section,
a device determination/selection section configured to
display one or more second identification images on the second display section, the second identification images having a correspondence with the first identification images and identifying the image display devices, and
receive selection, based at least on the second identification images, of at least one of the image display devices as a destination image display device and
an image supply section configured to supply the image to the selected destination image display device.

2. The image display system according to claim 1, wherein the device determination/selection section is further configured to
display, in addition to the second identification images, one or more candidate images on the second display section,
create a correspondence between the candidate images and the second identification images, and
supply the candidate images to the selected destination image display device based on the correspondence.

3. The image display system according to claim 1, wherein
each of the first identification images and each of the second identification images having the correspondence, respectively, are the same image.

4. The image display system according to claim 1, wherein
each of the image display devices includes a first storage section configured to store the first identification image, and
the image supply device obtains the first identification images from each of the image display devices, and displays the first identification images as the second identification images.

5. The image display system according to claim 4, wherein the image supply device further includes:
a management section configured to provide, when any of the first identification images received from the image display devices are the same or similar with each other, a change instruction to at least one of the image display devices so that the first identification images are no longer the same or similar.

6. The image display system according to claim 1, wherein
the image supply device includes a storage section configured to store the second identification images, and
each of the image display devices obtains one of the second identification images from the image supply device, and displays the second identification image as the first identification image.

7. The image display system according to claim 1, wherein
the device determination/selection section presents a plural number of image display devices as a group for selection as the destination image display device.

8. An image supply device adapted to supply at least one image to one or more image display devices, comprising:
a display section;
a device determination/selection section configured to
display one or more identification images on the display section to identify the image display devices, and
receive selection, based at least upon the identification images, of at least one of the image display devices as a destination image display device; and
an image supply section configured to supply the image to the selected destination image display device.

9. An image display device comprising:
a storage section configured to store an identification image; and
a display section configured to receive the identification image from the storage section and to display the identification image.

10. The image display device according to claim 9, wherein the storage section stores a plurality of identification images, and
the image display device further includes a selection section configured to select an arbitrary identification image from among the plurality of identification images stored in the storage section.

11. The image display device according to claim 9, further comprising:
a receiving section configured to receive another identification image externally from the image display device.

12. A method of controlling a supply of an image between an image supply device and one or more image display devices configured to display the image, comprising:
displaying second identification images on the image supply device, each of the second identification images having a one-to-one correspondence with first identification images displayed on the image display devices;
receiving selection, based at least on the second identification images, of at least one of the image display devices as a destination image display device; and
supplying the image to the selected destination image display device.

13. A computer program product embodied in a computer readable medium and comprising instructions executable by a computer to control image supply between an image supply device and one or more image display devices configured to display the image, the instructions executable to perform functions comprising:
displaying second identification images on the image supply device, each of the second identification images having a one-to-one correspondence with first identification images displayed on the image display devices;
receiving selection, based at least on the second identification images, of at least one of the image display devices as a destination image display device; and
supplying the image to the selected destination image display device.
